(19) United States
(12) Patent Application Publication
(10) Pub. No.: US 2023/0155163 A1
(43) Pub. Date: May 18, 2023

(54) Formation Method For Secondary Battery

(71) Applicant: SK On Co., Ltd., Seoul (KR)

(72) Inventors: Ji Won Na, Daejeon (KR); Sung Yeop Kim, Daejeon (KR); Eun Soo Cho, Daejeon (KR)

(21) Appl. No.: 17/987,175

(22) Filed: Nov. 15, 2022

(30) Foreign Application Priority Data
Nov. 15, 2021 (KR) 10-2021-0156914
Nov. 14, 2022 (KR) 10-2022-0151190

(51) Int. Cl. H01M 10/04; H01M 50/105; H01M 50/317; H01M 10/44

(52) U.S. Cl. CPC H01M 10/0468; H01M 50/105; H01M 50/317; H01M 10/44

(57) ABSTRACT

Provided is a formation method of a secondary battery, more particularly, to a method for removing gas generated during formation process of a secondary battery. The formation method includes a pre formation operation for pre-charging a pouch-type secondary battery in which an electrode assembly and an electrolyte are sealed, the pouch-type secondary battery including a pocket for gas collection; a primary degassing operation for forming a piercing in the pocket for gas collection, primarily degassing the gas generated during the pre-formation operation in real time through the piercing, and then sealing the piercing; and a secondary degassing operation for aging and secondarily degassing the pre-formed secondary battery.

### CROSS-REFERENCE TO RELATED APPLICATIONS

This application claims priority to Korean Patent Application No. 10-2021-0156914, filed Nov. 15, 2021 and Korean Patent Application No. 10-2022-0151190, filed Nov. 14, 2022, the disclosures of which are hereby incorporated by reference in their entireties.

### BACKGROUND OF THE INVENTION

### Field of the Invention

The present disclosure relates to a formation method for a secondary battery, and more particularly, to a method of removing gas generated during a formation process of a secondary battery.

### Description of Related Art

Recently, a rechargeable battery capable of being charged and discharged has been widely used as an energy source of a wireless mobile device or an auxiliary power device. In addition, the secondary battery is also attracting attention as a power source for a vehicle such as an electric vehicle (EV) , a hybrid electric vehicle (HEV), a plug-in hybrid electric vehicle (Plug-In HEV), and the like, which is being proposed as a method to solve air pollution such as that resulting from a conventional gasoline vehicle, a diesel vehicle, and the like, using fossil fuels.

Such a secondary battery is manufactured through the formation process after an electrode assembly is assembled in a form in which it is embedded in a battery case together with an electrolyte. The formation process stabilizes a battery structure and makes the same usable through a process of charging, aging, and discharging the assembled battery.

In the process of charging, aging, and discharging, a large amount of gas may be generated due to a side reaction between gas resulting from a positive electrode active material and a positive electrode active material and an electrolyte. The gas generated as described above may swell the battery case or may remain between electrodes to prevent a uniform and smooth reaction of the electrodes. Due thereto, there may be a problem in that a life of the battery is greatly reduced. Therefore, it is necessary to remove gas generated during a formation process.

Typically, a pouch-type secondary battery is obtained in a process of forming a pocket for gas collection, collecting internal gas generated in a formation process during initial charging on one side of a pouch case, to collect all of the generated gas, and then performing degassing, removing the internal gas after the formation process is completed, and then sealing the same.

Meanwhile, due to the recent trend for high capacitance and high performance of secondary batteries, an amount of initial gas generated is gradually increasing, and when the large amount of gas is generated, the battery may swell to cause various quality problems.

However, such a pocket for gas collection is removed after the formation process, and an additional pouch is required to be used to form such a gas collection pocket. In general, a pouch used for installing a pocket gas collection corresponds about ½ of an amount of Pouch required to manufacture one secondary battery, resulting in excessive pouch consumption, which leads to an increase in material costs.

Therefore, if the amount of the pouch can be reduced by reducing the size of the pocket for gas collection, cost reductions can be achieved.

### SUMMARY OF THE INVENTION

An aspect of the present disclosure is to solve a problem of increasing a cost of materials required due to an increase in a size of a pocket for gas collection in a pouch-type secondary battery.

Specifically, gas generated during Pre-Charging is removed from the gas collection pocket in advance before a degassing process to prevent enlargement of the gas collecting pocket.

The e invention relates to an formation method for a secondary battery, the formation method for a secondary battery including: a pre formation operation for pre-charging a pouch-type secondary battery in which an electrode assembly and an electrolyte are sealed, the pouch-type secondary battery including a pocket for gas collection, to generate gas, a primary degassing operation for forming a piercing in the pocket for gas collection, and primarily degassing the gas generated during the pre-formation operation in real time through the piercing, and then sealing the piercing; and a secondary degassing operation for aging and secondarily degassing the pre-formed secondary battery.

The pre formation operation may be performed at a state of charge (SOC) of 100% or less.

The pre formation operation may be performed in a state in which a secondary battery is pressed and heated using a pressing member.

The pressing may be applying pressure to both electrode surfaces of the secondary battery.

The pressing may be applying pressure to an area of 50% or more of an area of an electrode surface of the secondary battery.

The pressing and heating may be performed by pressing a pressing member, heated to a temperature of 20 to 100° C. to a pressure of 10000 kgf or less.

The pressing member may have a size having an area of 50% or more and 200% or less with respect to an overall area of the electrode surface.

The piercing may be formed in a region of 40% or more of an area from a center line longitudinally dividing the pocket for gas collection in half to an outermost side in one or both directions.

The piercing may be formed on both surfaces of the pocket for gas collection.

The primary degassing may be performed by suctioning with a vacuum.

The primary degassing may be performed by vacuum suctioning on both surfaces of the pocket for gas collection.

The primary degassing is preferably performed in a state in which external air is blocked.

The secondary degassing operation includes an operation of removing a pocket for gas collection.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a diagram schematically illustrating the concept of accommodating an electrode assembly in a case having a pocket for gas collection.

FIG. 2 is a diagram schematically illustrating a pouch-type secondary battery in which an electrode assembly is accommodated in a battery case having a pocket for gas collection.

FIG. 3 is a diagram schematically illustrating a pre-formation process of generating gas by the pre-formation process, and moving the generated gas to a pocket for gas collection.

FIG. 4 is a diagram schematically illustrating a pocket for gas collection in which a piercing is formed to remove gas generated during a pre-formation process and accommodated in the gas collection pocket.

FIG. 5 is a diagram schematically illustrating a primary degassing process of removing gas through a piercing formed in a pocket for gas collection.

FIG. 6 is a diagram schematically illustrating a concept of sealing a pierced region after primary degassing.

FIG. 7 (a) is an image of the pouch battery cell (100% of a pocket for gas collection) prepared in Reference Examples 1 and 2, FIG. 7(b) is an image of the pouch battery cells (75% of a pocket for gas collection) prepared in Comparative Example 1 and Example 1, and FIG. 7 (c) is an image of the pouch battery cell (50% of a pocket for gas collection) prepared in Comparative Example 2 and Example 2.

FIGS. 8(a) and 8(b) are an image of portions of a terrace (FIG. 8(a)) and a corner (FIG. 8(b)) of a pouch battery cell after the pouch battery cell prepared in Comparative Examples 1 and 2 is fully charged, FIG. 8(a) illustrating a battery cell obtained in Comparative Example 1, and FIG. 8(b) illustrating a battery cell obtained in Comparative Example 2.

FIG. 9 is an image taken of a surface of the pouch battery cell prepared in Example 1.

FIG. 10 is a graph obtained by measuring a change in a capacitance retention rate of cells after storing the battery cells obtained in Reference Examples 1 and 2 and Comparative Examples 1 and 2 for 12 weeks under high-temperature storage conditions of SOC of 96% and 55° C., and illustrating the result thereof.

FIG. 11 is a graph obtained by measuring a change in discharge DC-IR of cells after storing the battery cells obtained in Reference Examples 1 and 2, Comparative Examples 1 and 2, and Examples 1 and 2 for 12 weeks under high-temperature storage conditions of SOC of 96% and 55° C., and illustrating the result thereof.

### DESCRIPTION OF THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed, as will be apparent to one of ordinary skill in the art, with the exception of operations necessarily occurring in a certain order. Also, descriptions of functions and constructions that would be well known to one of ordinary skill in the art may be omitted for increased clarity and conciseness.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “including”, “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, exemplary embodiments will be described with reference to various examples. However, embodiments of the present disclosure may be modified in various other forms, and the scope of the present disclosure is not limited to the embodiments described below.

The present disclosure relates to a novel formation method applied during manufacturing a secondary battery and a formation process, and the formation method of the present disclosure includes a pre formation operation, a primary degassing operation, and a secondary degassing operation.

The formation method of the present disclosure may be suitably applied to a pouch-type secondary battery. Specifically, in the pouch-type secondary battery, an electrode assembly having a structure in which a separator is interposed between a positive electrode and a negative electrode may be sealed together with an electrolyte inside a pouch-type battery case.

The electrode assembly is not particularly limited, and may be a stack-type electrode assembly in which two or more negative electrodes and positive electrodes are alternately stacked, a stack-and-folding type electrode assembly in which the two or more negative electrodes and positive electrodes are alternately stacked, the negative electrode and the positive electrode being wound by a rectangular separator, and a jelly roll-type electrode assembly in which a negative electrode and a positive electrode are stacked with a separator as a boundary, the negative electrode and the positive electrode being wound. Furthermore, the electrode assembly may be one electrode assembly formed by a combination of two or more thereof, or an electrode assembly in which two or more electrode assemblies are stacked.

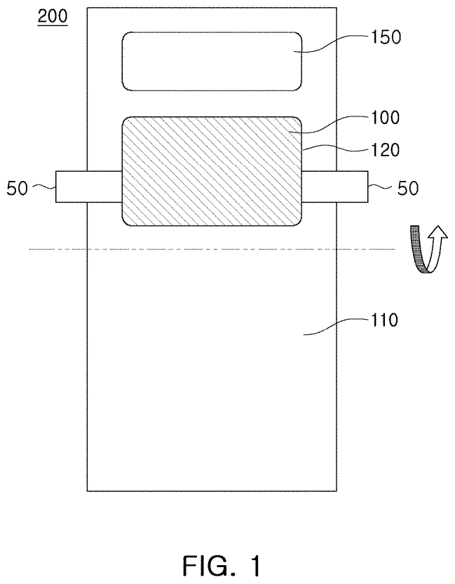

As illustrated in FIG. 1, the electrode assembly 100 is accommodated in a pouch-type battery case 110. The battery case 110 may be provided with an accommodating portion 120 and a pocket for gas collection 150 in which the electrode assembly 100 is located, and the accommodating portion 120 and the pocket for gas collection 150 may be formed with a groove for the accommodating portion 120 and the pocket for gas collection 150 of a predetermined shape by pressing and elongating a pouch provided as the battery case 110.

After the electrode assembly 100 is placed in the accommodating portion 120 of the battery case 110, the battery case 110 may be sealed by folding the battery case 110 according to a size of a main room of the electrode assembly 100, or covering a separate cover case and then sealing an outer peripheral surface of the battery case 110 by thermal fusion, so that a secondary battery 200 having the pocket for gas collection 150 can be manufactured.

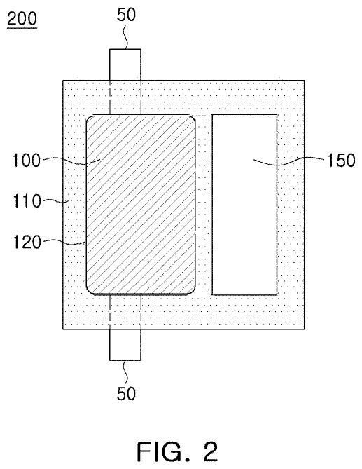

Specifically, as illustrated in FIG. 2, in a state in which the electrode assembly 100 is positioned in the accommodating portion 120, the outer circumferential surface of the battery case 110 is sealed to be sealed, and a space between the accommodating portion 120 of the electrode assembly 100 and the pocket for gas collection 150 may be sealed. In this case, a flow path through which gas can move from the accommodating portion 120 to the pocket for gas collection 150 may be formed between the accommodating portion 120 and the pocket for gas collection 150.

The secondary battery 200 thus obtained may be a bi-directional cell in which a lead tab 50 is drawn out in both directions as illustrated in FIG. 1, as well as a multi-tap cell in which a pair of lead tabs 50 are drawn out in both directions. Also, it is not particularly limited as the secondary battery 200 may be a unidirectional cell in which all of the lead tabs 50 are drawn out in one direction.

In the pouch-type secondary battery 200, a formation process of the secondary battery is performed in a state containing an electrolyte. In the formation process of the present disclosure, a main formation process is performed after performing a pre formation process.

The pre formation may be performed by charging, may be the first charging/discharging operation among the formation operation of the secondary battery, and may be referred to as an operation of pressurizing and heating the secondary battery 200 using the pressing member 170 and charging and discharging the secondary battery 200 at the same time.

The pre formation process is to remove a portion of the gas generated in the overall formation process of the secondary battery 200 before the main formation process.

In particular, an amount of gas generated by the formation process is most generated at the beginning of the formation process, and as in the present disclosure, by performing the pre formation process, a significant amount of gas generated during the overall formation process can be removed in advance.

Through the pre formation process, lithium in the secondary battery and an electrolyte chemically react to form a solid electrolyte intermediate (SEI) uniformly on the negative electrode.

When a portion of the amount of gas generated therefrom is removed in advance, the size of the pocket for gas collection 150 may be reduced compared to when all of the gas generated during the formation process is collected, and the battery case 110 may be expanded due to a large amount of gas, so that it is possible to prevent degradation of quality due to damage to the battery case 110, as well as to prevent secondary risks due thereto in advance.

Charging for the pre formation may be performed within a range of 100% of a state of charge (SOC), and may be, for example, within a range of 95% or less, 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, or 10% or less, and more specifically, within a range of 1 to 70%, 1 to 50%, 1 to 30%, 1 to 20%, 1 to 10%, 3 to 20%, and 3 to 10%, but an embodiment thereof is not limited thereto.

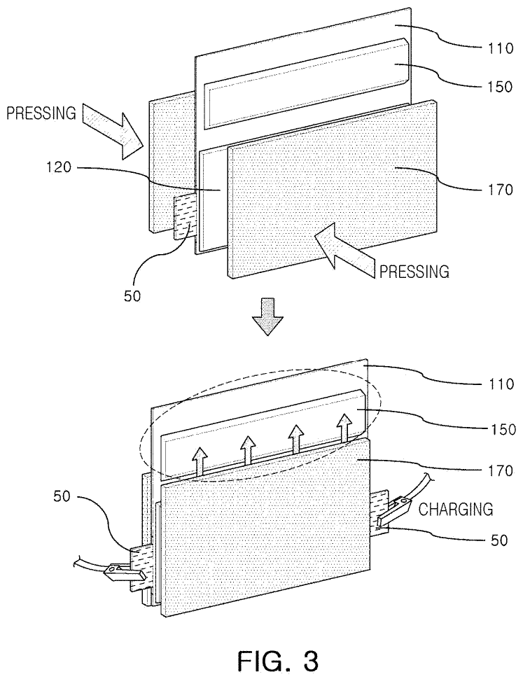

The pre formation process may be performed in a state in which the battery case 110 of the secondary battery is not excessively expanded using a pressing member 170 such as a predetermined jig, and for example, as illustrated in FIG. 3, the pre formation process may be performed by charging an external surface of the sealed battery case 110 in a pressed state using pressing members 170. Specifically, the pre formation process may be performed by charging while pressing the same using the pressing member 170 on both upper and lower surfaces in a thickness direction of the secondary battery 200 in which the electrode assembly 100 is accommodated in the battery case 110 and sealed, that is, on both electrode surfaces of the secondary battery 200.

By performing the pre-formation process in a pressed state, the gas generated in the pre-formation process does not remain between a contact interface of an electrode and a separator, and can be more easily moved to the pocket for gas collection 150.

The pressing may be performed with respect to an area of 50% or more, for example, an area of 70% or more, 80% or more, and 90% or more, and the pressing may also be performed to an area of 100%, that is, the overall electrode surface.

The pressing by the pressing member 170 is not particularly limited, and pressure can be applied to an extent to prevent the battery case 110 from expanding and deforming due to the gas generated during the pre-formation process, and pressure in which it is possible to prevent a phenomenon that a contact surface of an electrode inside the electrode assembly 100 and a separator is lifted by gas and to be sufficiently in close contact during the pre-formation process may be applied.

The pressure is not limited thereto, but pressure of 10,000 kgf/cm² or less may be applied, for example, pressure of 0.1, 0.5, 0.7, 1, 3, 5, 7, 10, 20, 30, 50 or 100 kgf/cm² or more, and pressure of 500, 700, 1,000, 2,000, 3,000, 5,000, 7,000, or 10,000 kgf/cm² or less may be applied.

The size of the pressing member 170 is not particularly limited as long as it can be pressed in the same area as described above with respect to the overall area of the electrode surface to be pressed. Accordingly, the pressing member 170 may have a size of 50% or more, for example, 60% or more, 70% or more, 80% or more, or 90% or more with respect to an area of a surface corresponding to an electrode surface of the electrode assembly 100, and may have an area having the same size as that of the electrode surface. Furthermore, as exemplarily illustrated in FIG. 3, the pressing member 170 may have a larger area than the electrode surface, and may have an area, for example, an area of 200% or less with respect to the area of the electrode surface, for example, an area of 190% or less, 180% or less, 170% or less, 160% or less, 150% or less, 140% or less, 130% or less, 120% or less, and 110% or less.

The shape of the pressing member 170 is not particularly limited, but may have a different shape from the electrode surface of the secondary battery 200 to be pressed by the pressing member 170, and may have the same shape. For example, the pressing member 170 has the same shape as an electrode surface of the secondary battery 200, which means the pressing member 170 and the electrode surface of the secondary battery 200 may have the same planar shape, and may have a reduced or enlarged shape at a predetermined magnification. In this case, the magnification may be an area ratio of the pressing member 170 to the electrode surface.

Furthermore, in order to more easily move the gas generated in the pre formation process to the pocket for gas collection 150, preferably, the pressing member 170 may apply uniform pressure the overall surface of the secondary battery 200 when pressing. To this end, the pressing member 170 may have a thickness of 5 to 30 mm, although it is different depending on the material, strength, and the like.

The pressing member 170 is not particularly limited as long as it can provide heat and pressure to the battery case 110. More specifically, the pressing member 170 may include a heating means (not shown) capable of applying heat together with pressure to the battery.

The heating may be performed so that a temperature of the pressing member 170 is in a range of 20 to 100° C. The heating may be performed at 20° C. or higher, 30° C. or higher, 40° C. or higher, or 50° C. or higher and 100° C. or lower, 90° C. or lower, 80° C. or lower, 70° C. or lower, or 60° C. or lower. When the pre formation process is performed by being heated to the above temperature range, a larger amount of gas may be induced, but when heated to a temperature exceeding 100° C., the quality of the secondary battery 200 may deteriorate, and may also cause a fire.

Through the pre formation process as described above, the generated gas moves to the gas collection pocket 150 and is collected, and a degassing process of removing the gas collected in the pocket for gas collection 150 is performed. Here, the degassing process is distinguished from the degassing process of removing gas generated by the main formation process and is referred to as a primary degassing process.

More specifically, the primary degassing process may be performed simultaneously with the pre-formation. That is, the primary degassing may be performed in real time according to the gas generation by the pre charging while performing the pre formation process of generating gas by pre-charging the secondary battery.

In this case, the real-time refers to performing the primary degassing when gas is generated in the pre formation operation or when gas is collected in the pocket for gas collection 150, and includes performing primary degassing during a process in which gas is generated by at least pre-charging the secondary battery.

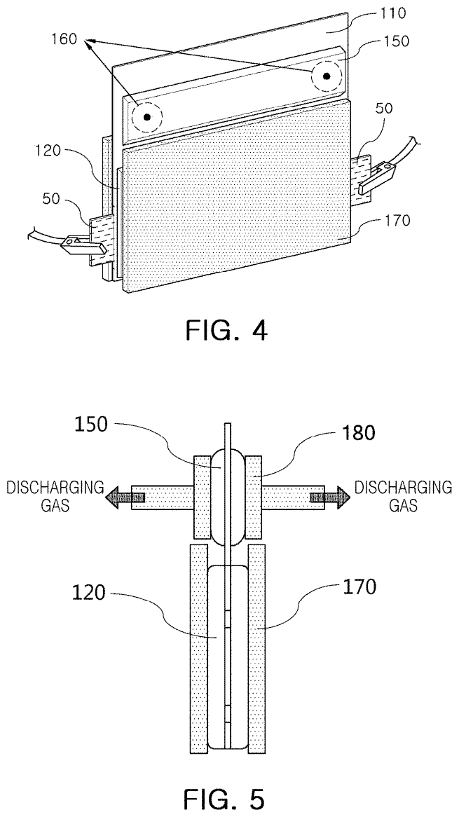

As illustrated in FIG. 4, the primary degassing process is performed by forming a piercing 160 in a portion of the pocket for gas collection 150 and discharging gas in the pocket for gas collection 150 through the piercing 160.

For example, as illustrated in FIG. 5, the discharge the gas may be performed by abutting the jig 180 to both surfaces of the pocket for gas collection 150 and vacuum suctioning the gas through the piercing 160.

The formation position of the piercing 160 is not particularly limited, but may be formed on an edge of the pocket for gas collection 150 as illustrated in FIG. 4. Since a main formation process is performed after removing the gas generated by the pre formation, it is necessary to remove the piercing 160 by sealing, and the piercing 160 may be formed on an edge of the pocket for gas collection 150 in terms of ease of removal by sealing.

For example, as illustrated in FIG. 4, the piercing 160 may be formed in a position, spaced apart from a center line CL longitudinally dividing the pocket for gas collection in a longitudinal direction in half, and more specifically, when the center line CL is 0%, and both outermost sides of the pocket for gas collection 150 are 100%, respectively, the piercing 160 may be formed in a position equal to 30% or more, 50% or more, 70% or more, 80% or more, or 90% or more. In addition, the piercing 160 may be formed on either side based on the center line CL, and may be formed on both sides.

Furthermore, FIG. 4 illustrates an example in which one piercing 160 is formed in each position, the present disclosure is not limited thereto, and two or more piercings may be formed in plural.

In addition, when a piercing 160 is formed in a central portion of a pocket for gas collection 150, vacuum suctioning is performed to remove the gas filled in a large amount in the pocket for gas collection 150 narrows a space the pocket for gas collection 150 between both jigs 180, butted on both sides, making it difficult to smoothly proceed with the gas removal process. Therefore, as illustrated in FIG. 5, it is more desirable that the piercing 160 is formed at the edge of the pocket for gas collection 150 in the same direction as a direction in which an electrode tab is drawn out. The number of the piercings 160 may be 1 or 2 or more formed on one surface of the pocket for gas collection 150, and may be respectively formed at positions corresponding to both surfaces thereof. For more rapid gas discharge, the plurality of piercings 160 may be formed, and may be respectively formed at positions corresponding to both surfaces thereof.

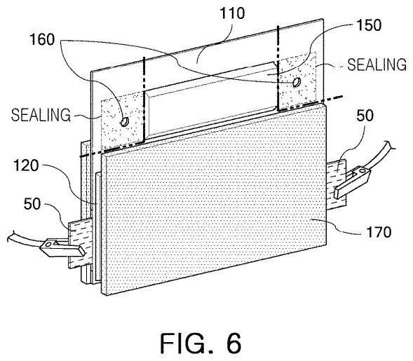

After the gas is removed from the pocket for gas collection 150, as illustrated in FIG. 6, a region of the piercing 160 is locally sealed to seal the battery case 110. The sealing may be performed by the same method as the conventional thermal sealing of the battery case 110, and is not particularly limited.

From the operation of forming the piercing 160 in the pocket for gas collection 150 to discharge the gas collected in the pocket for gas collection 150 by the pre-formation, a primary degassing operation for gas discharge and an operation of thermal sealing 110 is preferably performed in a state in which external air is completely blocked in terms of safety.

In the primary degassing operation, degassing is performed by attaching a vacuum pad to a portion of the piercing 160, thereby effectively removing gas inside the secondary battery 200, and further, it is possible to prevent the external air from coming into contact with an inside of the secondary battery 200, so that it is possible to prevent degradation of the quality of the secondary battery due to moisture contained in the outside air.

According to the method of the present disclosure as described above, by generating gas by the pre-formation process, and removing the generated gas in advance, the size thereof may be reduced, compared to the size of the pocket for gas collection, required when the gas generated during the overall process of the conventional formation process is collected and finally degassed, and accordingly, it is possible to significantly reduce an amount of a pouch film used, thereby realizing cost reduction.

In particular, in a high-performance battery generating a large amount of gas, the amount of gas generated is significantly large, and when a degassing process is performed after an overall formation process is performed, a larger pocket for gas collection is required for collecting a large amount of gas. According to the present disclosure, it is possible to suppress an increase in the size of the pocket for gas collection even in the high-performance battery.

In addition, when a degassing process is performed after the overall formation process is performed as in the conventional method, a problem, in which the battery case is deformed due to the expansion of the battery case, so that product quality and battery safety are degraded, may be prevented.

After performing the primary degassing process according to the method of the present disclosure, a process of performing a secondary degassing process of performing charging according to a conventional formation process, and removing the gas generated thereby from the pocket for gas collection, wherein the pocket for gas collection is finally removed from the secondary battery.

### EXAMPLE

Hereinafter, the present disclosure will be described in more detail through specific examples. The following examples are only examples to help the understanding of the present disclosure, and the scope of the present disclosure is not limited thereto.

<Manufacturing Pouch Battery Provided with Pocket for Gas Collection>

### Reference Examples 1 and 2

Two pouch-type battery cases made of a laminate sheet and having an accommodating portion for accommodating an electrode assembly and a pocket for gas collection were prepared.

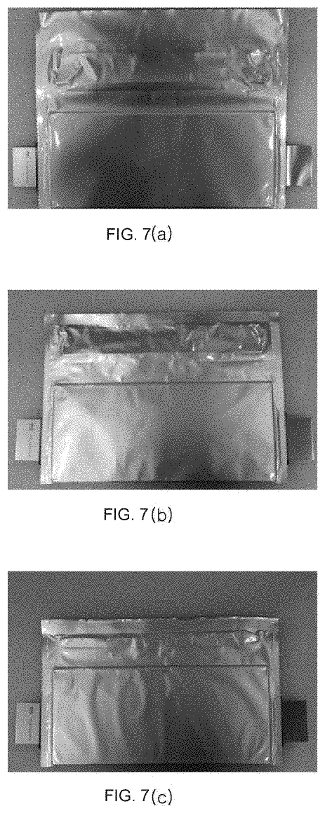

An electrode assembly was accommodated in the accommodating portion of the pouch battery case, an electrolyte was injected, so that two identical battery cells sealed by thermal fusion were prepared (Reference Examples 1 and 2, respectively). The battery cell of Reference Example 1 was photographed and illustrated in FIG. 7 (a).

A pre-charging process was performed with respect to the prepared battery cells at SOC 0%→3% (0.25C)→50% (0.85C), and after performing full charge without a separate gas removal process, the pocket for gas collection was removed.

### Comparative Examples 1 and 2

When a size of the pocket for gas collection provided in the pouch battery case of Reference Example 1 is 100%, the same pouch-type secondary battery was manufactured except that the size of the pocket for gas collection was reduced to 75% (Comparative Example 1) and 50% (Comparative Example 2). Each of the pouch-type secondary batteries was photographed and illustrated in FIGS. 7 (b) and 7 (c).

A pre charging process was performed with respect to the prepared battery cell at SOC 0%→3% (0.25C)→50% (0.85C), and after performing full charging without a separate gas removal process, the pocket for gas collection was removed.

### Examples 1 and 2

The same pouch battery cells as those of Comparative Examples 1 and 2 were respectively prepared (Examples 1 and 2).

A pre charging process was performed with respect to the prepared battery cells at SOC 0%→3% (0.25C)→degassing→50% (0.85C). The gas removal was performed in a manner that, as illustrated in FIG. 4, piercing was performed at both edges (a region of 80% from a center line CL) of both surfaces of a pocket for gas collection of a pouch battery case, and then, as illustrated in FIG. 5, a vacuum pad was placed at each pierced site, and pressed to discharge the gas through the vacuum pad.

After the pre charging process is completed, it was fully charged, and the pocket for gas collection was removed.

<Evaluation of Cell Appearance>

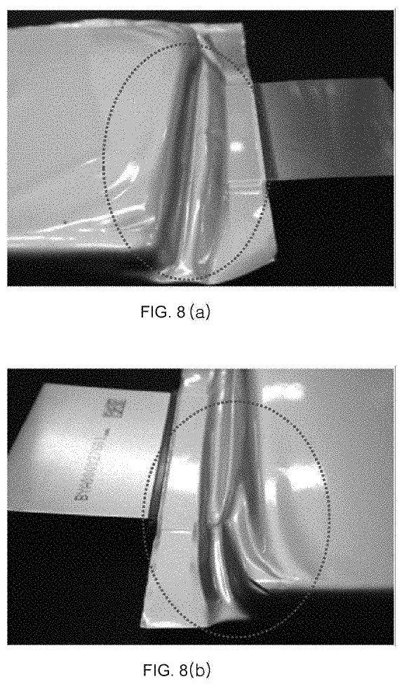

In Comparative Examples 1 and 2, in which a size of a pocket for gas collection was reduced, deformation of a pouch occurred in terrace and corner portions of a cell as illustrated in FIGS. 8(a) and 8(b). Although a large amount of gas is generated during a formation process, the size of the pocket for gas collection is reduced, which affects a battery case and causes deformation of a case.

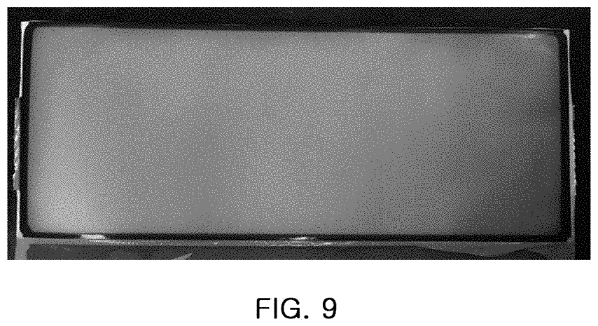

On the other hand, in Examples 1 and 2, although the size of the pocket for gas collection was reduced by 25% and 50%, as illustrated in FIG. 9, it can be seen that surface quality of the battery case is maintained in a good state, so that no deformation occurs. This is because, by removing gas generated during the pre-charging process, an effect of reducing the size of the pocket for gas collection could be prevented. Furthermore, by reducing the size of the pocket for gas collection, an overall amount of pouch used may be reduced, thereby obtaining a cost reduction effect.

<Cell Performance Test>

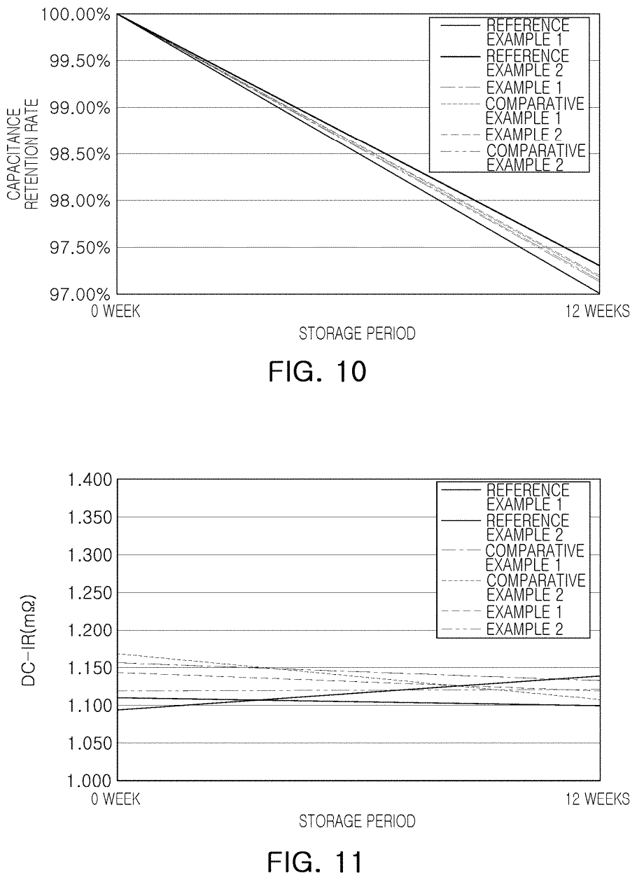

For battery cells obtained in Reference Examples 1 and 2, Comparative Examples 1 and 2, and Examples 1 and 2, described above, after storing the battery cells for 12 weeks under high-temperature storage conditions of 96% SOC and 55° C., a capacitance retention rate and a change in discharge DC-IR of the cells were tested, and the results thereof were illustrated in FIGS. 10 and 11. FIG. 10 is a graph illustrating a change in a capacitance retention rate, and FIG. 11 is a graph illustrating a change in discharge DC-IR.

From FIGS. 10 and 11, it can be seen that the capacitance retention rate and discharge DC-IR slightly changed after the storage period for 12 weeks, but did not show a significant difference, and there was almost no change even compared to Reference Examples 1 and 2.

Therefore, when the formation method according to the present disclosure is applied, it s possible to significantly reduce the amount of pouch used form the pocket for gas collection while maintaining the surface quality of the secondary battery, thereby reducing the cost of manufacturing the secondary battery.

As set forth above, according to the method of the present disclosure, by removing the gas generated during the pre-charging process in advance, a size of a pocket for gas collection for collecting a large amount of gas generated during the formation process may be reduced, so that a material of a pouch required for the pocket for gas collection may be saved.

Furthermore, it is possible to reduce a problem of deterioration of a battery quality that may occur due to swelling of the battery case due to generation of a large amount of gas, thereby improving quality stability of the product.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

### DESCRIPTION OF REFERENCE NUMERALS

50: Lead Tab
100: Electrode Assembly
110: Battery Case
120: Accommodating Portion
150: Pocket for Gas Collection
160: Piercing
170: Pressing Member
180: Jig
200: Secondary Battery

What is claimed is:

1. A formation method of a secondary battery, the formation method comprising:
a pre formation operation for pre-charging a pouch-type secondary battery in which an electrode assembly and an electrolyte are sealed, the pouch-type secondary battery including a pocket for gas collection;
a primary degassing operation for forming a piercing in the pocket for gas collection, primarily degassing the gas generated during the pre formation operation in real time through the piercing, and then sealing the piercing; and
a secondary degassing operation for aging and secondarily degassing the pre-formed secondary battery.

2. The formation method of a secondary battery of claim 1, wherein the pre formation operation is performed within 100% of a state of charge (SOC).

3. The formation method of a secondary battery of claim 1, wherein the pre formation operation is performed under pressure and heating using a pressing member.

4. The formation method of a secondary battery of claim 3, wherein the pressing applies pressure to both electrode surfaces of the secondary battery.

5. The formation method of a secondary battery of claim 3, wherein the pressing applies pressure to an area of 50% or more of a total area of an electrode surface of the secondary battery.

6. The formation method of a secondary battery of claim 3, wherein the pressing and heating are performed by pressing a pressing member, heated to a temperature of 20 to 100° C. to a pressure of 10000 kgf or less.

7. The formation method of a secondary battery of claim 3, wherein the pressing member has a size of an area of 50% or more and 200% or less with respect to an area of the electrode surface.

8. The formation method of a secondary battery of claim 1, wherein the piercing is formed in a region of 40% or more of a region from a center line longitudinally dividing the pocket for gas collection in half to an outermost side in one or both directions.

9. The formation method of a secondary battery of claim 8, wherein the piercing is formed on both surfaces of the pocket for gas collection.

10. The formation method of a secondary battery of claim 1, wherein the primary degassing is performed by vacuum suctioning.

11. The formation method of a secondary battery of claim 10, wherein the primary degassing is performed by suctioning with a vacuum from both surfaces of the pocket for gas collection.

12. The formation method of a secondary battery of claim 1, wherein the primary degassing is performed in a state in which outside air is blocked.

13. The formation method of a secondary battery of claim 1, wherein the secondary degassing comprises an operation of removing the pocket for gas collection.
